(19) United States
(12) Patent Application Publication
(10) Pub. No.: US 2014/0317015 A1
(43) Pub. Date: Oct. 23, 2014

(54) FINANCIAL ADVISOR RANKING SYSTEMS AND METHODS

(71) Applicant: Robert J. Dillon, Denver, CO (US)

(72) Inventor: Robert J. Dillon, Denver, CO (US)

(21) Appl. No.: 14/249,995

(22) Filed: Apr. 10, 2014

Related U.S. Application Data
(60) Provisional application No. 61/810,557, filed on Apr. 10, 2013.

(51) Int. Cl. G06Q 30/02; G06Q 40/00

(52) U.S. Cl. CPC G06Q 30/0282; G06Q 40/00
USPC 705/347

(57) ABSTRACT

Methods and systems are provided to compute a financial advisor score based on demographic and professional data, or variables, associated with a financial advisor. In particular, subgroups based on the values of the variables for multiple financial advisors are created; based on sales attributed to the subgroup of financial advisors and the number of financial advisors in each subgroup, a weighting for each variable associated with each financial advisor is derived. A plurality of variable weights associated with each financial advisor may be added together and scaled yielding a financial advisor score.

### CROSS REFERENCE TO RELATED APPLICATION

This application claims priority to U.S. Provisional Application No. 61/810,557, filed Apr. 10, 2013, entitled “Financial Advisor Ranking (FAR) Systems and Methods, the entire disclosure of which is hereby incorporated by reference in its entirety for all that it teaches and for all purposes.

### FIELD OF THE DISCLOSURE

An exemplary embodiment is generally directed toward generating a value representative of how likely or unlikely a Financial Advisor is to produce for a given company.

### BACKGROUND

Companies that sell financial products such as mutual funds or variable annuities need to make sales through one of the approximately 650,000 Financial Advisors registered with the Financial Industry Regulatory Authority, Inc. (FINRA). Demographic and professional data are available for many of these financial advisors from third-party vendors. Although companies that sell financial products should have historical sales data showing which Financial Advisors have produced sales for them in the past, absent any other data, these companies have no way of knowing which Financial Advisors are more likely to produce for them as well as which Financial Advisors are unlikely to produce for them.

### SUMMARY

It is with respect to the above issues and other problems that the embodiments presented herein were contemplated. It is, therefore, one aspect of the present disclosure to provide a system and method that at least uses demographic and professional information about each registered financial advisor, combined with a given company's historical sales data, to calculate an exemplary score identifying a likelihood of the financial advisor to produce for the given company. Using the Financial Advisor Ranking (FAR) system, companies are able to focus their resources on the financial advisors most likely to produce for them and avoid the FAs least likely to produce for them, thus saving time and money and increasing sales.

An exemplary embodiment of the Financial Advisor Ranking system at least uses demographic and professional information about financial advisors to build a computer-based model to predict an output on one or more display devices to a user(s) which financial advisors are likely to produce (i.e., have sales of variable annuities, mutual funds or other financial products) for a given company and which financial advisors are not likely to produce. An exemplary embodiment of the system assigns a FAR (Financial Advisor Ranking) Score ranging between 1 and 100 to each financial advisor that can produce, or sell financial products, for the given company based upon the relationship of demographic and professional variables to historical sales data. A separate FAR Score can be calculated by one or more computing devices for each product line (Mutual Funds, Variable Annuities, etc.) for each financial advisor. In some embodiments, a FAR score may be localized such that the FAR score is calculated based on a subset of financial advisors for a given geographic location, region, and/or area. For example, a FAR score may be calculated for all financial advisors located in a city, located in one or more zip codes, and/or having certain area codes.

The exemplary FAR scoring system works with any type of financial product that is sold through, recommended, or purchased by licensed professionals for which demographic and professional data is available. Non-limiting examples include: mutual funds, variable annuities, fixed annuities, life insurance, bonds, 529 plans (college saving plans) or even commodities such as gold, silver, etc. That is, a financial product predictive model may be utilized to generate a FAR Score for each financial advisor that can or does sell the financial product or advises on the financial product. In accordance with one exemplary embodiment, only the variables used in the Variable Annuity and Mutual Funds predictive models are described, while the variables for the other financial products may be similar and would be readily apparent to one of ordinary skill in the art.

Once a FAR Score has been determined by the computing device(s) for all the financial advisors that can produce or have produced for a company, the user may also merge industry-wide sales and market share data with the FAR results to improve financial advisor targeting. Such market share data is generally available from third-party vendors.

### 8 Exemplary Variables Used in a Mutual Fund Predictive Model

The following 8 exemplary demographic and professional variables may be used in an exemplary embodiment of a Mutual Fund predictive model; this data may be obtained for each financial advisor that can potentially produce for the company in order to produce a FAR Score. Such data is generally available commercially from third party vendors.

TABLE 1
8 Exemplary Variables for Mutual Fund Predictive Model

1. Number of States FA is Licensed In (Num_States)
2. Number of Licenses (Num_Licenses)
3. Years of Experience (Years_Experience)
4. Age (Age)
5. Assets Under Management (AUM)
6. Gender (Gender)
7. Gross Annual Production (Gross_Prod)
8. Whether FA Sells or Advises on Mutual Funds (Sells_MFs)

### 7 Exemplary Variables Used in Variable Annuity Predictive Model

The following 7 exemplary demographic and professional variables may be used in an exemplary embodiment of a Variable Annuity predictive model; this data may be obtained for each FA that can potentially produce for the company in order to produce a FAR Score for Variable Annuities. Such data is generally available commercially from third party vendors.

TABLE 2
7 Exemplary Variables for a Variable Annuity Predictive Model

1. Number of States FA is Licensed In (Num_States)
2. Number of Licenses (Num_Licenses)
3. Years of Experience (Years_Experience)
4. Age (Age)
5. Assets Under Management (AUM)
6. Gross Annual Production (Gross_Prod)
7. Whether FA Sells or Advises on Variable Annuities (Sells_VAs)

It is thus one aspect of the present invention to provide a method for generating an indication of a financial advisor's ability to produce for a financial product, the method comprising obtaining a financial advisor profile associated with each financial advisor of a plurality of financial advisors, the financial advisor profile comprising a plurality of variables; generating a weighting associated with each variable of the financial advisor profile; and generating a financial advisor score for each financial advisor by summing the weighting associated with each variable of the financial advisor profile. In accordance with some aspects of the present invention, generating the weighting associated with each variable of the financial advisor profile further includes, for each variable of the plurality of variables: creating two or more subgroups based upon a value of the variable for each financial advisor of the plurality of financial advisors; associating at least one of the two or more subgroups for each variable of the plurality of variables to each financial advisor; and generating a subgroup weighting for each subgroup of the two or more subgroups based on an amount of financial advisors in each subgroup and respective sales of the financial product attributed to the amount of financial advisors in each subgroup; and assigning a weighting to each variable of the financial advisor profile based on the associated subgroup and the subgroup weighting.

It is another aspect of the present invention to provide a method for generating an indication of a financial advisor's ability to produce for a financial product. Such a method may include obtaining a financial advisor profile associated with each financial advisor of a plurality of financial advisors, the financial advisor profile comprising a plurality of variables indicating a number of states the financial advisor is licensed in, a number of licenses associated with the financial advisor, a number of years of experience associated with the financial advisor, an age of the financial advisor, assets under management by the financial advisor, and a gross annual production of the financial advisor; generating a weighting associated with each variable of the financial advisor profile; and generating a financial advisor score for each financial advisor by summing the weighting associated with each variable of the financial advisor profile.

It is yet another aspect of the present invention to provide a computing based system to calculate a financial advisor's ability to produce. The computing based system may include a database; one or more processors; and a financial advisor scoring unit, the financial advisor scoring unit being configured to obtain from the database a plurality of variables associated with each financial advisor of a plurality of financial advisors, generate a weighting associated with each variable associated with the financial advisor, and generate a financial advisor score for each financial advisor by summing the weighting associated with each variable associated with the financial advisor.

The present disclosure may provide a number of advantages depending on the particular aspect, embodiment, and/or configuration. These and other advantages will be apparent from the disclosure and discussion herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “module” as used herein refers to any known or later developed hardware, software, firmware, artificial intelligence, fuzzy logic, or combination of hardware and software that is capable of performing the functionality associated with that element.

The terms “determine”, “calculate” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

Exemplary embodiments of the present disclosure are described in conjunction with the appended figures where:

FIG. 1 is a block diagram of a financial advisor scoring system in accordance with embodiments of the present disclosure;

FIG. 2 depicts one or more financial profiles having variables in accordance with an exemplary embodiment of the present disclosure;

FIGS. 3A-3B illustrate an exemplary pivot table and/or cross-tabulation result that can be utilized in accordance with an exemplary embodiment of the present disclosure;

FIGS. 4A-4B depict a layout and/or display containing financial advisor information, including a financial advisor ranking, in accordance with at least some embodiments of the present disclosure;

FIG. 5 illustrates an example report that can be created in accordance with at least some embodiments of the present disclosure;

FIG. 6 illustrates one or more components of a financial advisor scoring system in accordance with embodiments of the present disclosure;

FIG. 7 is a first flowchart depicting an exemplary method for generating a financial advisor ranking score in accordance with embodiments of the present disclosure;

FIG. 8 is a flowchart depicting an exemplary method for obtaining financial advisor information in accordance with embodiments of the present disclosure;

FIG. 9 is a flowchart depicting an exemplary method utilized to create subgroups in accordance with embodiments of the present disclosure;

FIG. 10 is a flowchart depicting an exemplary method utilized in accordance with embodiments of the present disclosure;

FIGS. 11A-11C depict exemplary tables that may be utilized in accordance with embodiments of the present disclosure; and

FIG. 12 depicts a flowchart depicting an exemplary method for obtaining financial advisor information in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

Furthermore, while embodiments of the present disclosure will be described in connection with a model to predict Mutual Fund sales, it should be appreciated that embodiments of the present disclosure are not so limited. In particular, embodiments of the present disclosure can be applied to a Variable Annuity predictive model, as the steps involved in the Variable Annuity predictive model are similar or the same to the Mutual Fund model except that 7 variables may be used instead of 8. Although some variables are used in both models, not all variables are utilized in each model. Moreover, and as previously described, the exemplary scoring system works with any type of financial product that is sold through, recommended, or purchased by licensed professionals for which demographic and professional data is available. Accordingly, the usage of Mutual Fund sales examples is for illustrative purposes only and should not be construed as limiting the claims.

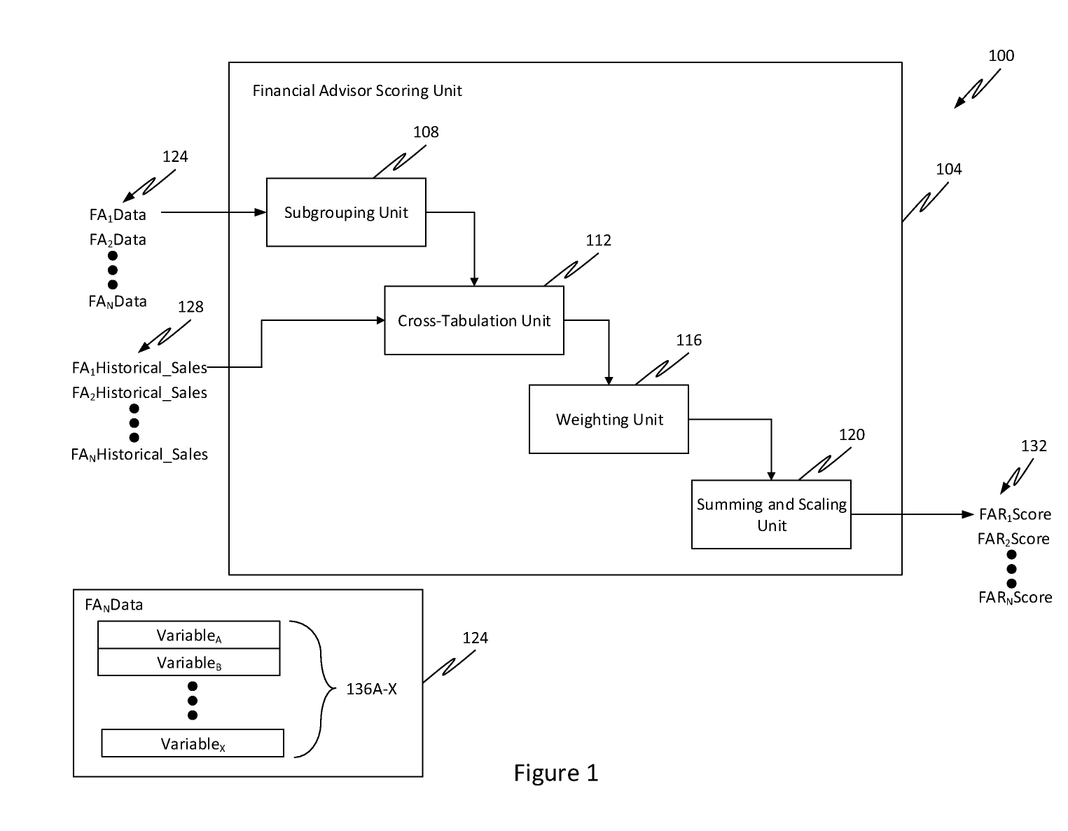

FIG. 1 shows a block diagram illustrating a functional configuration of a financial advisor ranking system (FARS) 100 in accordance with at least some embodiments of the present disclosure. The FARS 100 at least includes a financial advisor scoring unit 104 that generates a financial advisor score (FAR Score) for each financial advisor based on financial advisor data and financial advisor historical sales data. As illustrated in FIG. 1, financial advisor data is represented as FA_{N}Data 124, where subscript N identifies a particular financial advisor. Likewise, financial advisor historical sales is represented as FA_{N}Historical_Sales 128, where subscript N again identifies a particular financial advisor. Although illustrated as separate data items, financial advisor historical sales data FA_{N}Historical_Sales 128 may be provided together with the financial advisor data FA_{N}Data 124. Each FA_{N}Data 124 data item includes a plurality of variables 136A-X.

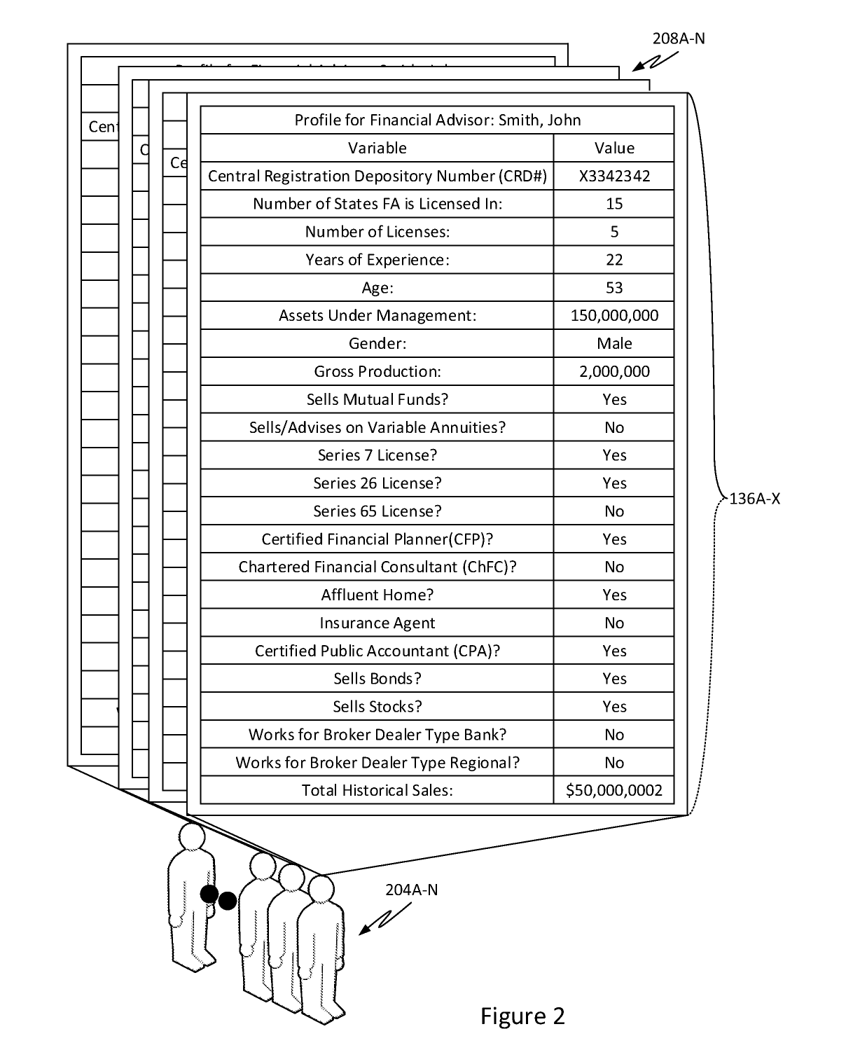

Referring to FIG. 2, each variable 136A-X may correspond to a demographic and/or professional variable utilized in a particular model. Such demographic and/or professional variables may be utilized in one or more models to predict the likelihood, or non-likelihood, that a financial advisor will produce for a specified company. As an example, some embodiments of the present invention may utilize some or all of the following non-limiting variables: (1) Number of States a financial advisor is Licensed in; (2) Number of Licenses; (3) Years of Experience; (4) Age of the financial advisor; (5) Assets Under Management, or the monetary value of the assets currently managed by the financial advisor; (6) Gender; (7) Gross Annual Production, or the financial advisor's gross annual commissions; (8) Whether the financial advisor sells mutual funds; (9) Whether the financial advisor sells and/or advises on Variable Annuities; (10) Whether the financial advisor possesses a Series 7 License, also referred to as the General Securities Representative Exam; (11) Whether the financial advisor possesses a Series 26 License, also referred to as the Investment Company Products/Variable Contracts Limited Principal License; (12) Whether the financial advisor possesses a Series 65 License, also referred to as the Investment Advisor Representative License; (13) Whether the financial advisor is a Certified Financial Planner (CFP); (14) Whether the financial advisor is a Chartered Financial Consultant (ChFC); (15) Whether the financial advisor possesses an affluent home; (16) Whether the financial advisor is an Insurance Agent; (17) Whether the financial advisor is a Certified Public Accountant (CPA); (18) Whether the financial advisor sells Bonds; (19) Whether the financial advisor sells Stocks; (20) Whether the financial advisor works for a Broker Dealer of the type Bank; and (21) Whether the financial advisor works for a Broker Dealer of the type Regional. Such information may be obtained from one or more third party sources and maintained in a database, or electronic format, for each financial advisor 204A-N. For example, a profile 208A-N may be created to contain the variable values for each financial advisor 204A-N.

Referring again to FIG. 1, the financial advisor scoring unit 104 generally includes a subgrouping unit 108, a cross-tabulation unit 112, a weighting unit 116, and a summing and scaling unit 120. As will be described later, the subgrouping unit 108, the cross-tabulation unit 112, the weighting unit 116, and the summing and scaling unit 120 may be implemented using a processor, such as a microprocessor. Further, the subgrouping unit 108, the cross-tabulation unit 112, the weighting unit 116, and the summing and scaling unit 120 provide the necessary functionality such that the financial advisor scoring unit 104 may generate a FAR Score for each financial advisor. That is, a FAR Score, represented by FAR_{N}Score 132, where subscript N identifies a particular financial advisor, may be generated for each financial advisor.

The Financial Advisor Scoring Unit 104 receives financial advisor data FA_{N}Data 124 from one or more data sources. For example, the financial advisor data FA_{N}Data 124 may comprise list of all financial advisors that can produce or have produced for Mutual Funds for a specified company including the financial advisor's unique FINRA CRD number (CRD#) and values for the variables used in the model. Such data is generally available from third party vendors. As previously discussed, such data may be imported into a database table and maintained throughout the FAR Score generation process. Alternatively, or in addition, such data may be maintained in a financial advisor profile 208A-N associated with an identified financial advisor 204A-N. For example, the financial advisor data FA_{N}Data 124 may reside within a database table and may be updated at random or predetermined times. Accordingly, the database table containing financial advisor data FA_{N}Data 124 may contain up to date and/or real-time information concerning one or more financial advisors.

The subgrouping unit 108 breaks each of the variables utilized in the predictive model into 3 to 6 subgroups of similar or equal size. For example, each variable is broken into 4 or 5 roughly similar sized groups. Some variables will only have 3 subgroups (e.g., Gender) while others (e.g., Age) may have 6 subgroups for example.

To determine the cutoff points for each subgroup in a variable, the subgrouping unit 108 may sort all the financial advisors by their value for the variable in ascending order. The first (lowest) value in the list may be the low range for subgroup1, for example. The value of the variable found 25% down the list (for example, if the list has 400,000 rows or financial advisors, go down to row 100,000) may then be used for the high value for subgroup1.

As another example, if a variable pertaining to Years of Experience (e.g., Years_Experience) is used in a predictive model, the values may range from 1 year of experience to 70 or more years of experience. Accordingly, the list of financial advisors may be sorted in ascending order by the value in the Years of Experience variable and the top 25% or so of financial advisors may comprise subgroup1, the 25% or so below subgroup1 may comprise subgroup2, the next lower 25% or so may comprise subgroup3 and the lowest 25% or so may comprise subgroup4. Any financial advisors for which there is no data for a variable may automatically be classified into the “Null/Unknown” subgroup. It is important to note that the subgroups may not always contain an equal number of financial advisors. For example, using the Years_Experience variable, the data may break down as follows:

TABLE 3

| Subgroup | Percent of FAs in each subgroup |
|---|---|
| More than 17 Years (subgroup4) | 20% |
| 9 to 17 Years (subgroup3) | 28% |
| 5 to 9 Years (subgroup2) | 26% |
| Less than 5 Years (subgroup1) | 21% |
| Null/Unknown | 5% |
| Total | 100% |

In some instances, it may be important to break a variable into 3 subgroups, 4 subgroups, 5 subgroups, or 6 subgroups, depending on the distribution of data and the possible variable values. In addition, the subgrouping unit 108 may break each variable into subgroups such that all subgroups for which data exists (i.e. not the Null/Unknown subgroup), contain between 15% and 30% of the financial advisors.

As another example, if a variable relating to gender is used in a predictive model, there may be three possible subgroups including: “Null/Unknown”, “Male” or “Female”. Many of the variables (Sells_MFs, Series7, CFP, ChFC, Affluent_Home, Insurance_Agent, CPA, Sells_Bonds, Sells_Stocks) have the following three subgroups: “Null/Unknown”, “Yes”, or “No”. Age may be broken down into six subgroups: “20s”, “30s”, “40s”, “50s”, “60s”, “70+”.

The subgrouping unit 108 may then determine which subgroup each financial advisor falls into for each variable. For example, another variable, or record, may be created to hold the value of the subgroup that the financial advisor is in. In some embodiments, this new variable may correspond to another row in a database or a list. According to the value of the variable for each subgroup, the subgrouping unit 108 may determine which subgroup the financial advisor is in. As an exemplary embodiment, the subgroup a financial advisor is in for the variable Years_Experience may be determined according to the following:

TABLE 4

| Experience in Years | Subgroup Value |
|---|---|
| Null/Unknown | Null_Unknown |
| Less than 5 years | Less than 5 Years |
| Between 5 and 9 years | 5 to 9 Years |
| Between 9 and 17 years | 9 to 17 years |
| More than 17 years | More than 17 years |

To determine which of the five Years_Experience subgroups a financial advisor is in, the following exemplary Javascript may be used to calculate by a processor(s) the value for that column (the sample code below assumes that the name of the column showing the financial advisors years of experience is called “Years_Experience”.) A new column in a list or database to hold the value of the subgroup may be created having the name “Years_Experience_Group” (data type is string) and the following Javascript code determines the value of this column for each financial advisor:

TABLE 5

```
if (Years_Experience == null)
  ‘Null/Unknown’
else if (Years_Experience < 5)
  ‘Less than 5 Years’
else if (Years_Experience <= 9)
  ‘5 to 9 Years’
else if (Years_Experience <= 17)
  ‘9 to 17 Years’
else ‘More than 17 Years’
```

As one example, if a financial advisor has a value of 11 for Years_Experience, the value of the Years_Experience_Group will be ‘9 to 17 Years’. This process is then repeated for all variables utilized in the particular or specified predictive model. For example, at least the eight variables in Table 1 may be utilized in the Mutual Fund predictive model. As another example, at least the seven variables in Table 2 may be utilized in the Variable Annuity predictive model. Accordingly, for each of the above utilized variables, the subgroup in which the financial advisor falls into is identified and stored.

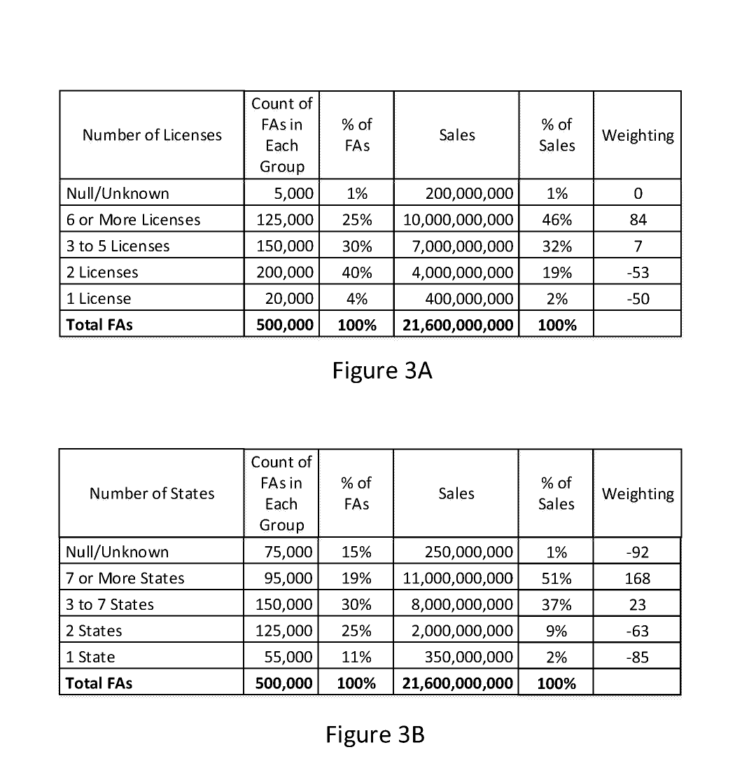

The cross-tabulation unit 112 may then receive financial advisor historical sales data FA_{N}Historical_Sales 128 and cross-tabulate each variable to determine a percentage of financial advisors that are in each subgroup as well as a percentage of a specified company's sales for each subgroup. In accordance with at least one embodiment of the present disclosure, a pivot table may be utilized. For example, as illustrated in FIG. 3A, hypothetical data for Company X shows a breakdown of financial advisors by subgroups for the Num_Licenses variable for both sales and number of financial advisors in each subgroup. As one skilled in the art can appreciate, financial advisors who have six or more licenses only account for twenty-five percent of all financial advisors but they account for forty-six percent of Company X's sales. Accordingly, this group of financial advisors would be a good group for Company X to target. Conversely, financial advisors with two licenses account for forty percent of all financial advisors yet produce only nineteen percent of Company X's sales. Accordingly, this group may be a good group to avoid.

As another example, as illustrated in FIG. 3B, hypothetical data for Company X shows a breakdown of financial advisors by subgroups for the Number of States variable for both sales and number of financial advisors in each subgroup. As one skilled in the art can appreciate, financial advisors who are licensed in seven or more states only account for nineteen percent of all financial advisors but they account for fifty-one percent of Company X's sales. Accordingly, this group of financial advisors would be a good group for Company X to target. Additionally, financial advisors who are licensed in three to seven states only account for thirty percent of all financial advisors but they account for thirty-seven percent of Company X's sales. Accordingly, this group of financial advisors would be a good group for Company X to target. Conversely, financial advisors licensed in two states account for twenty-five percent of all financial advisors yet produce only nine percent of Company X's sales. Accordingly, this group may be a good group to avoid.

Referring again to FIG. 1, the Weighting Unit 116 may use an algorithm to calculate a weighting for each subgroup such that “good” subgroups get positive numbers and “bad” subgroups get negative numbers. That is, the better or worse a subgroup is, the higher or lower the weighting will be. For example, the Weighting Unit 116 may utilize [Equation 1] to weight each subgroup.

$$\frac{\% of Sales - \% of Financial Advisors}{\% of Financial Advisors} 100 \qquad Equation 1$$

For example, utilizing Equation 1, the Weighting Unit 116 may calculate weights for each subgroup of the variable Num_Licenses_Group, according to the following:

TABLE 6

| Subgroup | Calculation | Weight |
|---|---|---|
| Null/Unknown | $\frac{1 - 1}{1} 100$ | 0 |
| 6 or More Licenses | $\frac{46 - 25}{25} 100$ | 84 |
| 3 to 5 Licenses | $\frac{32 - 30}{30} 100$ | 7 |
| 2 Licenses | $\frac{19 - 40}{40} 100$ | −53 |
| 1 License | $\frac{2 - 4}{4} 100$ | −50 |

In accordance with some embodiments of the present disclosure, the percentages of sales and the percentages of financial advisors may be rounded depending on a model. Accordingly, as the numbers above and the numbers in FIGS. 3A and 3B are for Company X, the numbers are hypothetical to illustrate the concept and total percentages may not equal 100 percent due to rounding error.

The above calculation is performed by the Weighting Unit for each of the variables utilized in the model. Accordingly, every subgroup of every variable will have a weighting. In the above example and in accordance with at least one embodiment, any financial advisors who have a null or unknown value will have a weighting of zero for this variable; financial advisors who have six or more licenses will have a weighting of eighty-four; financial advisors with three to five licenses will have a weighting of seven; financial advisors with two licenses will have a weighting of negative fifty-three and financial advisors with one license will have a weighting of negative fifty.

Accordingly, once all weights for each subgroup have been determined by the weighting unit 116, a weight can be assigned to each financial advisor for each variable in the model. For example, the weighting for the Num_Licenses variable is calculated by the following Javascript (note that all weightings below are hypothetical):

```
TABLE 7
if (Num_Licenses_Group == ‘Null/Unknown’)
  0
else if (Num_Licenses_Group == ‘6 or More Licenses’)
  84
else if (Num_Licenses_Group == ‘3 to 5 Licenses’)
  7
else if (Num_Licenses_Group == ‘2 Licenses’)
  −53
else if (Num_Licenses_Group == ‘1 License’)
  −50
```

As another example, the weighting for the number of states the financial advisor is licensed in (Num_States) variable is calculated by the following Javascript (note that all weightings below are hypothetical):

```
TABLE 8
if (Num_States_Group == ‘More than 7’)
  168
else if (Num_States_Group == ‘3 thru 7’)
  23
else if (Num_States_Group == ‘2 States’)
  −63
else if (Num_States_Group == ‘1 State’)
  −85
else if (Num_States_Group == ‘Null/Unknown’)
  −92
```

As another example, the weighting for the years of experience (Years_Experience) variable is calculated by the following Javascript (note that all weightings below are hypothetical):

```
TABLE 9
if (Years_Experience_Group == ‘Null/Unknown’)
  −10
else if (Years_Experience_Group == ‘More than 17 Years’)
  100
else if (Years_Experience_Group == ‘9 to 17 Years’)
  50
else if (Years_Experience_Group == ‘5 to 9 Years’)
  0
else if (Years_Experience_Group == ‘Less than 5 Years’)
  −50
```

As another example, the weighting for the age (Age) variable is calculated by the following Javascript (note that all weightings below are hypothetical):

TABLE 10

(Age_Group == ‘Null/Unknown’)
−10
else if (Age_Group == ‘20s’)
−75
else if (Age_Group == ‘30s’)
−25
else if (Age_Group == ‘40s’)
75
else if (Age_Group == ‘50s’)
50
else if (Age_Group == ‘60s’)
25
else if (Age_Group == ‘70+’)
−25

As another example, the weighting for the assets under management (AUM) variable is calculated by the following Javascript (note that all weightings below are hypothetical):

TABLE 11

if (AUM_Group == ‘Null/Unknown’)
−10
else if (AUM_Group == ‘Over $60M’)
150
else if (AUM_Group == ‘$10M to $60M’)
100
else if (AUM_Group == ‘$5M to $10M’)
50
else if (AUM_Group == ‘Less than $5M’)
0

As another example, the weighting for the gender (Gender) variable is calculated by the following Javascript (note that all weightings below are hypothetical):

TABLE 12

If (Gender_Group == ‘Null/Unknown’)
−10
else if (Gender_Group == ‘Male’)
25
else if (Gender_Group == ‘Female’)
−10

As another example, the weighting for the gross annual production (Gross_Prod) variable is calculated by the following Javascript (note that all weightings below are hypothetical):

TABLE 13
if (Gross_Prod_Group == ‘Null/Unknown’)
−10
else if (Gross_Prod_Group == ‘More than $600K’)
150
else if (Gross_Prod_Group == ‘$200K to $600K’)
100
else if (Gross_Prod_Group == ‘Less than $200K’)
50

As another example, the weighting for whether the financial advisor sells or advises on mutual funds (Sells_MFs) variable is calculated by the following Javascript (note that all weightings below are hypothetical):

TABLE 14

```
if (Sells_MFs_Group == ‘Null/Unknown’)
  −10
else if (Sells_MFs_Group == ‘Yes’)
  100
else if (Sells_MFs_Group == ‘No’)
  −25
```

After the Weighting Unit 106 has finished determining a weighting for each variable included in the model for each financial advisor, a total raw score may be calculated for each financial adviser by the summing and scaling unit 120. That is, the summing and scaling unit 120 adds the weighting for each variable for each financial advisor. An example Javascript code to calculate the total raw score is provided in Table 15.

TABLE 15

Num_States_Weighting +
Num_Licenses_Weighting +
Years_Experience_Weighting +
Age_Weighting +
AUM_Weighting +
Gender_Weighting +
Gross_Prod_Weighting +
Sells_MFs_Weighting

After the summing and scaling unit 120 calculates the raw score for each financial advisor, the raw scores are then scaled, and/or normalized, such that the data set is broken into 100 equal sized portions with 1% of the financial advisors being in each portion. For example, if the financial advisors are sorted in ascending order according to their total raw score, the financial advisor with the lowest total raw score should be at the top of the list and the financial advisor with the highest raw score should be at the bottom of the list. As one example, the sorted list of financial advisors may resemble table 16.

TABLE 16

| Row Number | CRD# | Total_Raw_Score |
|---|---|---|
| 1 | X1234567 | −1403 |
| 2 | X3342342 | −1403 |
| 3 | X3959595 | −1403 |
| 4 | X9983838 | −1401 |
| 5 | X9338944 | −1401 |
| . . . | . . . | . . . |
| . . . | . . . | . . . |
| 499,996 | X0923939 | 1315 |
| 499,997 | X0293838 | 1315 |
| 499,998 | X6859494 | 1316 |
| 499,999 | X1236543 | 1316 |
| 500,000 | X0988837 | 1316 |

Accordingly, every financial advisor that can produce for a specified company should have a FAR Score between 1 and 100 assigned to them. Additionally, there will be an almost equal amount of financial advisors (1% of the total number of financial advisors) for each FAR Score. In one embodiment, the FAR Score may be calculated according to the following equation:

$$FAR Score = \frac{Total\_Raw \_Score - Min\_Raw \_Score}{Max\_Raw \_Score - Min\_Raw \_Score} 100 \qquad Equation 2$$

The Summing and Scaling Unit 120 may then output the FAR_{N}Score 132 for each financial advisor, where subscript N identifies a particular financial advisor. The FAR_{N}Score 132 may be stored or otherwise maintained in association with the financial advisor. For example, if a profile 208A-N is utilized for a financial advisor 204A-N, the profile 208A-N may then be updated to reflect this FAR Score. Alternatively, or in addition, the FAR Score may be stored in a table and associated with a particular CRD# number. Accordingly, such information may then be used for targeting purposes.

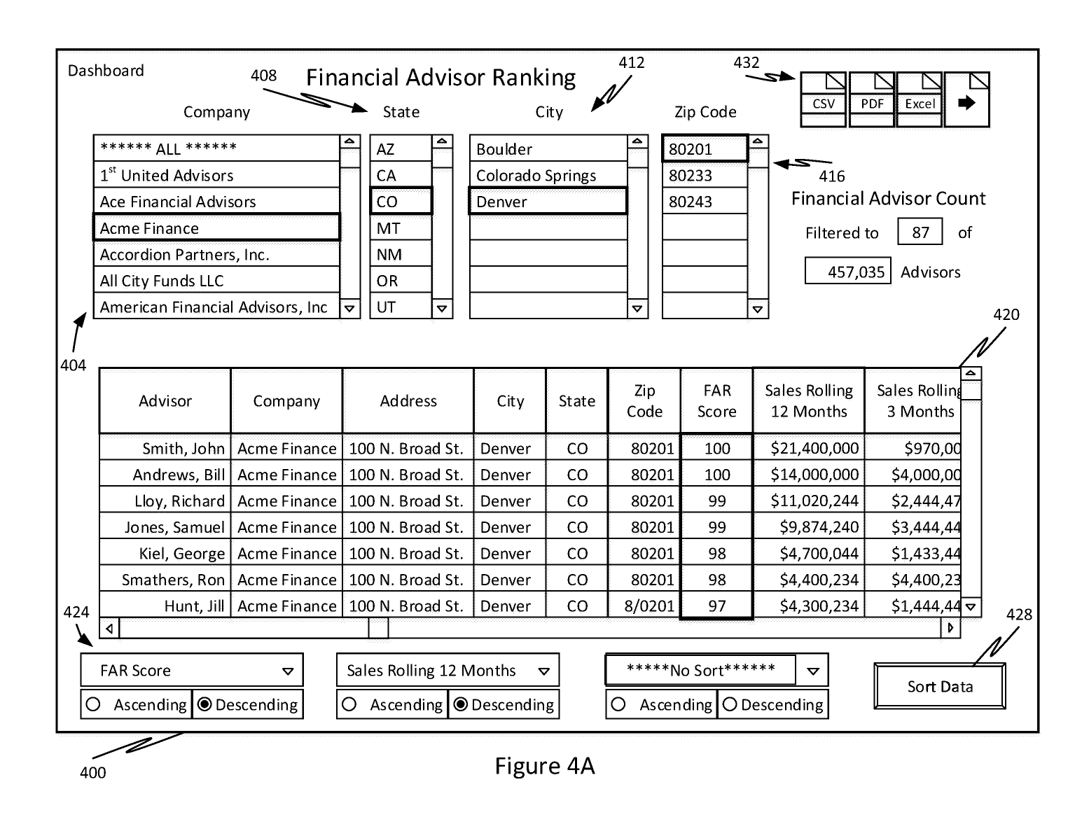

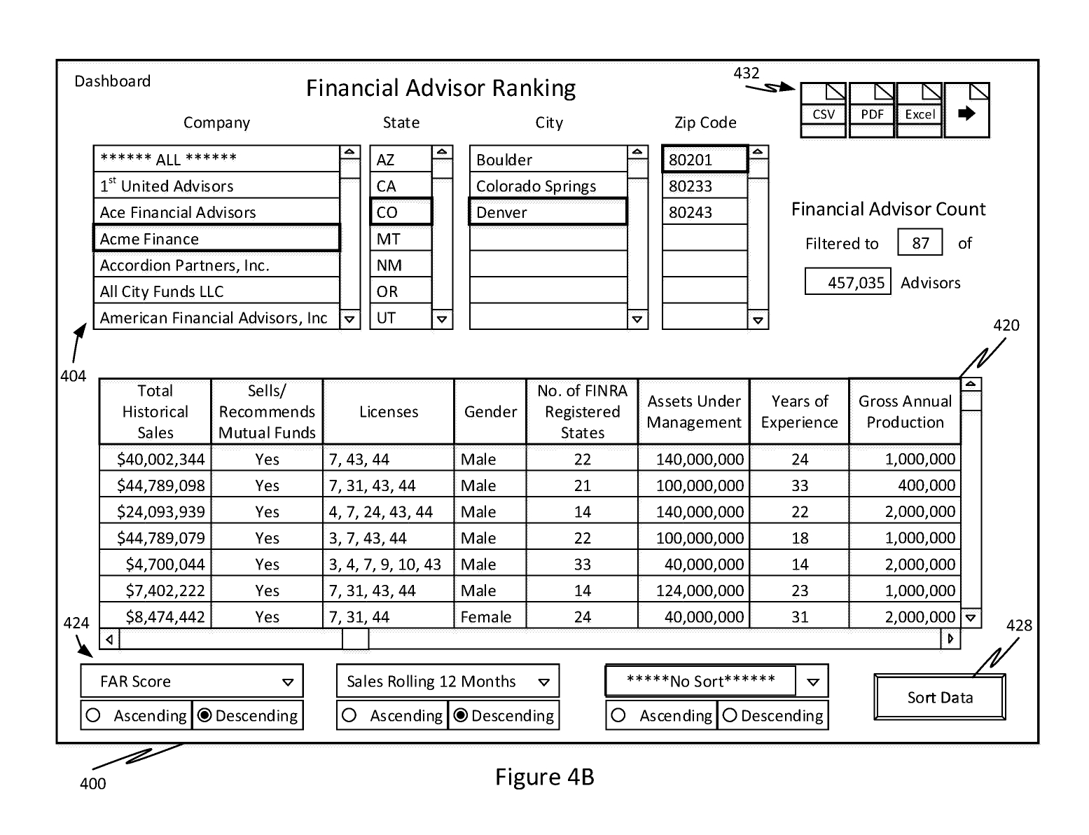

FIGS. 4A and 4B depicts an example layout illustrating how the results of the Financial Advisor Ranking system may be displayed to a user using a Financial Advisor Ranking Dashboard 400. For example, a user may filter the company he or she wants to target by clicking on the name in the Company listbox (Acme Finance in this example) 408. Then the states where Acme Finance has branches are shown in the State listbox 408. Once the user chooses 1 or more states, the cities where Acme Finance has offices will be shown in the City listbox 412. Once a city is chosen, the zip codes in that city where Acme Finance has offices are shown in the Zip Code listbox 416.

As depicted in FIG. 4A, of the 457,035 financial advisors that can produce for the user's firm, the user has filtered down to the Denver, Colo. 80201 branch of Acme Finance for financial advisors that have top FAR Scores. The resulting 87 financial advisors that meet such a criteria are shown in the main table 420. The sort buttons 424 and 428 at the bottom of the Financial Advisor Ranking Dashboard 400 allow the user to sort the results set by any of the columns in the data set. For example, the filtered results set is sorted by FAR Score in descending order and within FAR Score, by Sales Rolling 12 Months in descending order. This way, the best prospects are shown at the top and any prospects that have the same FAR Score will be sorted in descending order of Sales Rolling 12 Months. Knowing the FAR Score of financial advisors helps the user focus on the best prospects in the states and companies of interest to the user and avoid the worst prospects.

As depicted in FIG. 4B, additional details regarding the financial advisors can be displayed in the main table 420; in particular, some of the fields holding demographic and professional information are displayed. Additionally, the details, including the search criteria and the results of the search criteria, can be exported utilizing one of the export functions 432.

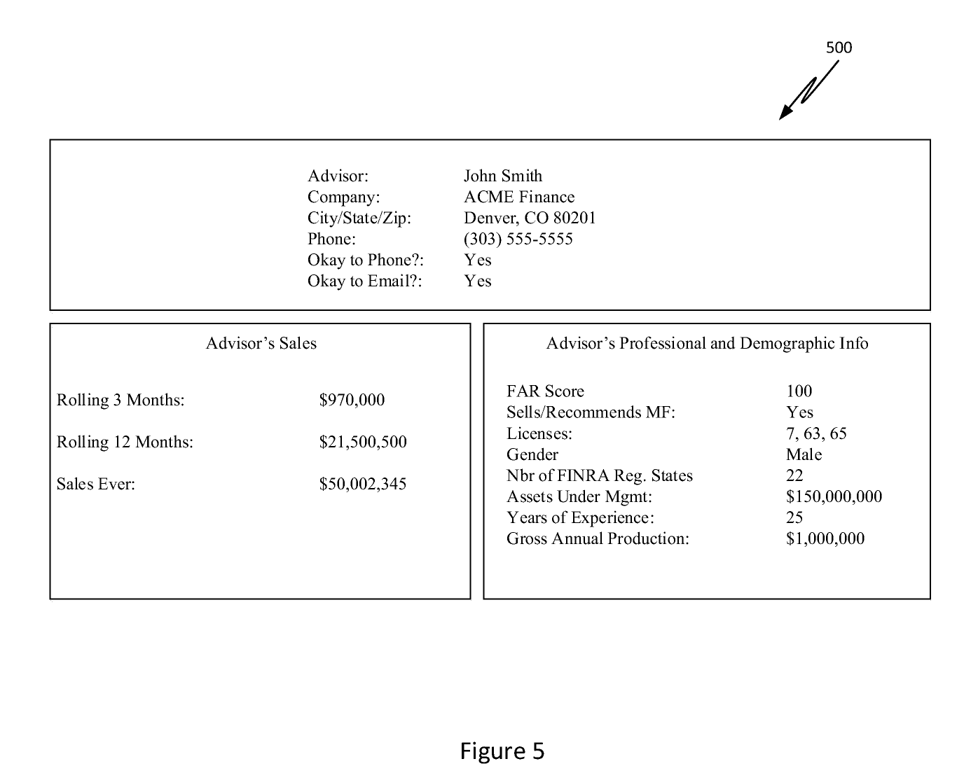

Additionally, as depicted in FIG. 5, if a user were to select, for instance, by double-clicking on a financial advisor's row, a report containing the details of the financial advisor may be generated and may be provided to the user.

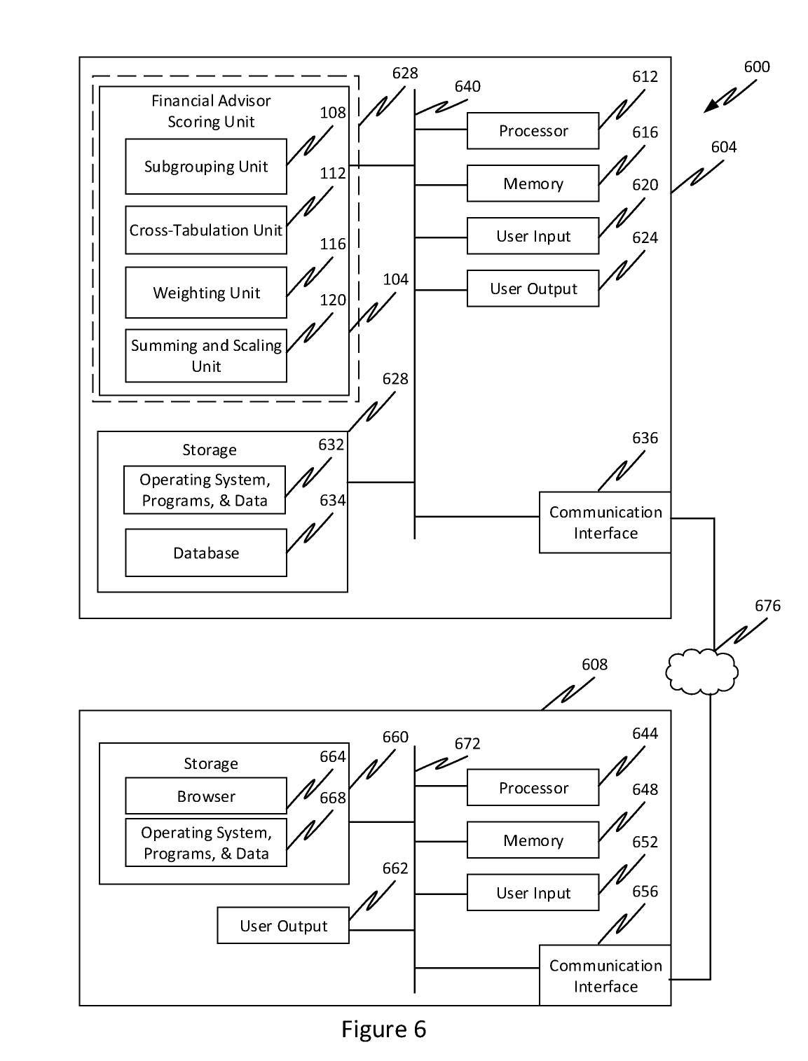

FIG. 6 depicts a high-level block diagram of an example computing environment for Financial Advisor Ranking System 600 having a computing device 604 in accordance with at least some embodiments of the present disclosure. Computing device 604 may include a processor 612, memory 616, one or more user input devices 620, such as a keyboard and a pointing device, and one or more user output devices 624, such as a display, speaker, and/or printer. Alternatively, or in addition, the user input 620 and the user output 624 may be combined into one device, such as a touch screen display. Computing device 604 may further include a communication interface 636 for communicating with another computing device 608, and/or the communication network 676.

Processor 612 is provided to execute instructions contained within memory 616 and/or storage 628. As such, the functionality of the computing device is typically stored in memory 616 and/or storage 628 in the form of instructions and carried out by the processor 612 executing such instructions. Accordingly, the processor 612 may be implemented as any suitable type of microprocessor or similar type of processing chip. One example of the processor 612 may include any general-purpose programmable processor, digital signal processor (DSP) or controller for executing application programming contained within memory 616 and/or storage 628. Alternatively, or in addition, the processor 612, memory 616, and/or storage 628, may be replaced or augmented with an application specific integrated circuit (ASIC), a programmable logic device (PLD), or a field programmable gate array (FPGA).

The memory 616 generally comprises software routines facilitating, in operation, pre-determined functionality of the computing device 604. The memory 616 may be implemented using various types of electronic memory generally including at least one array of non-volatile memory cells (e.g., Erasable Programmable Read Only Memory (EPROM) cells or FLASH memory cells, etc.). The memory 616 may also include at least one array of dynamic random access memory (DRAM) cells. The content of the DRAM cells may be pre-programmed and write-protected thereafter, whereas other portions of the memory may selectively be modified or erased. The memory 616 may be used for either permanent data storage and/or temporary data storage.

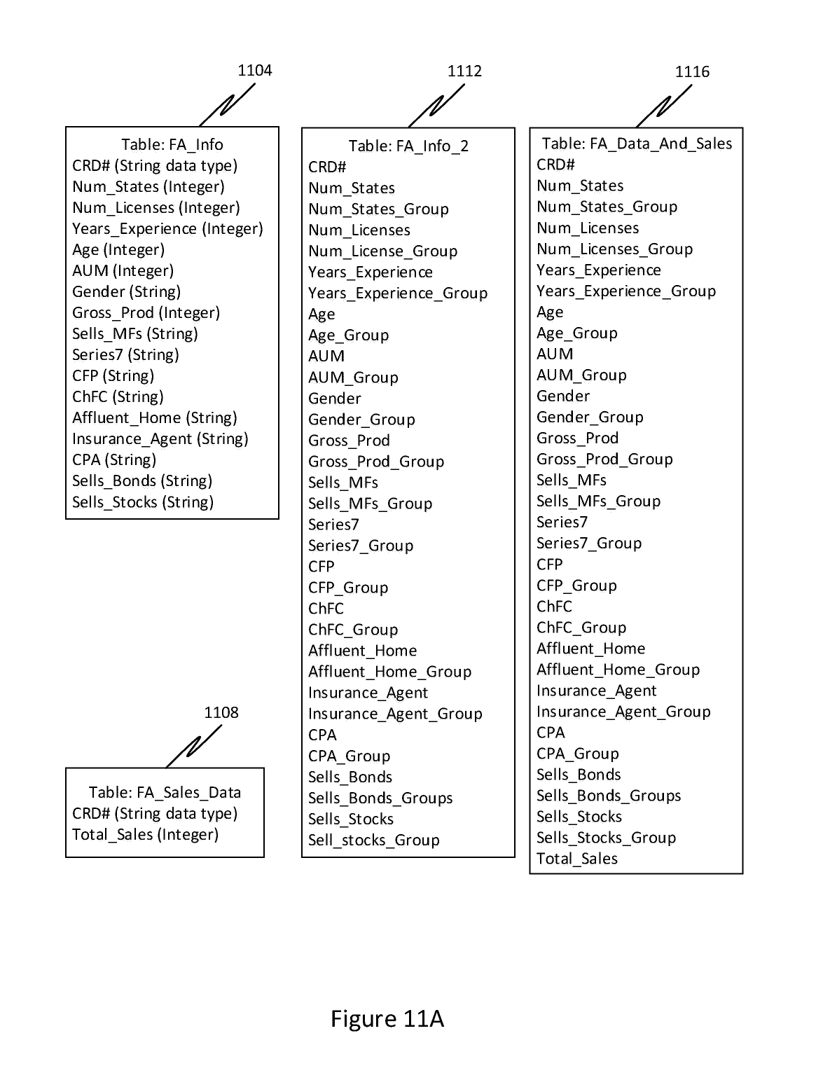

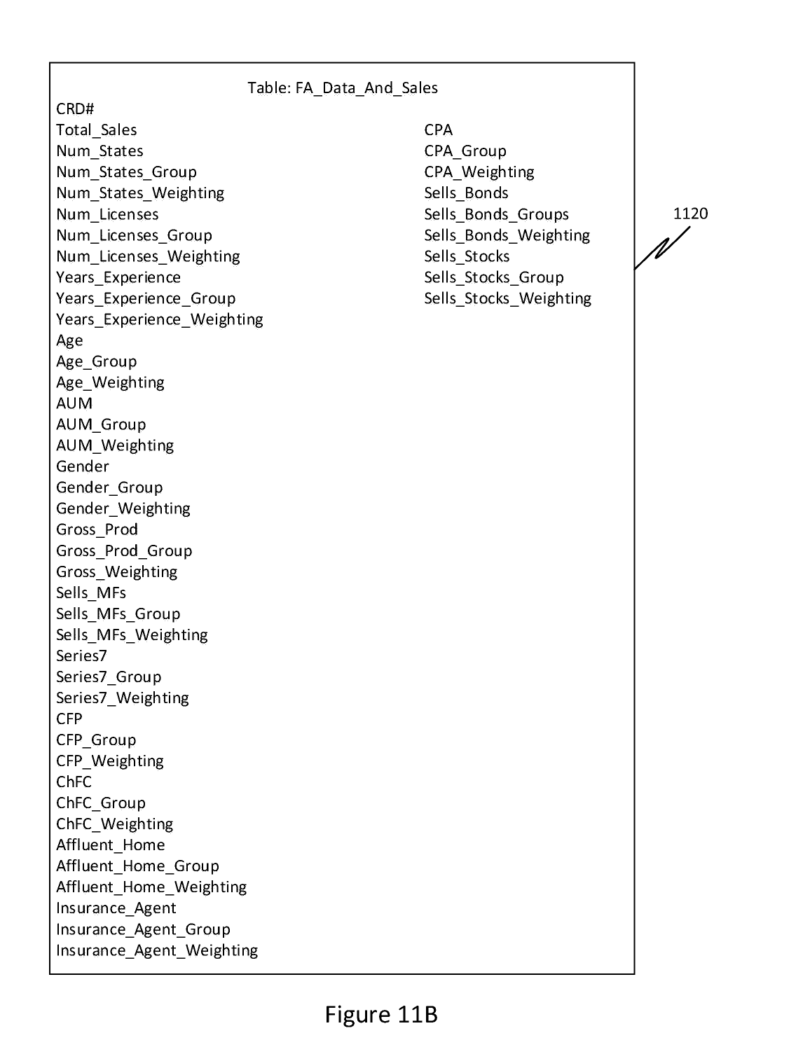

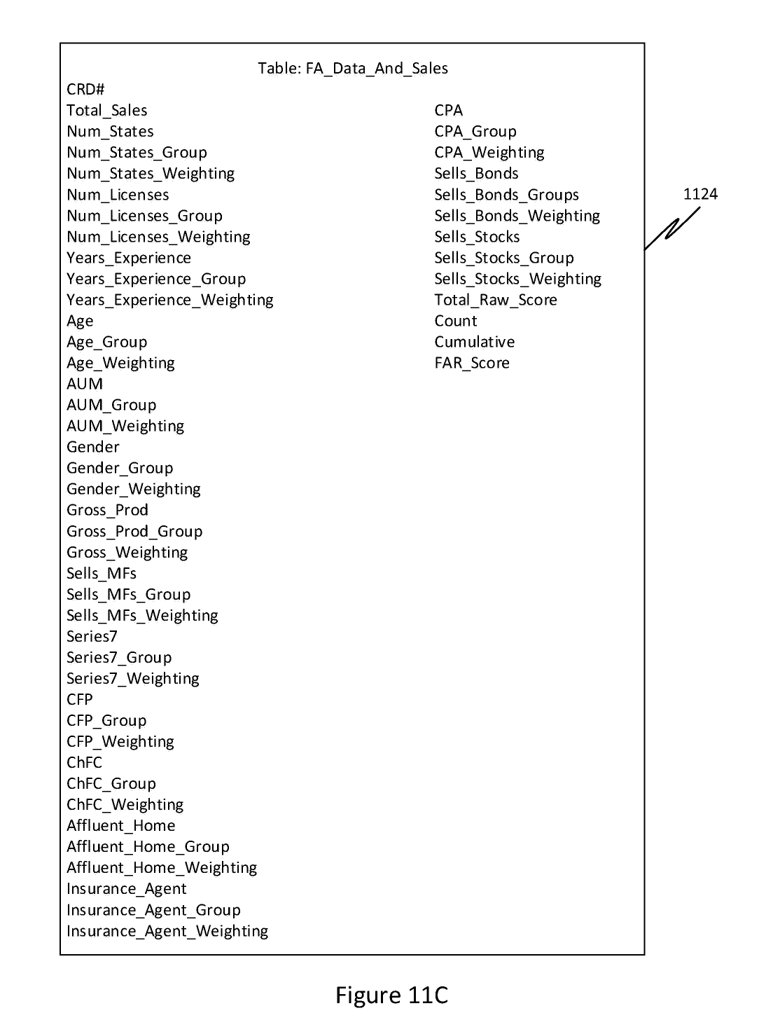

The data storage 628 may generally include storage for programs and data. For example, data storage 628 may provide storage for a financial advisor scoring unit 104 including the subgrouping unit 108, cross-tabulation unit 112, weighting unit 116, and summing and scaling unit 120, and/or the general operating system and other programs and data 632. Additionally, the data storage 628 may also include a database portion 634 for storing data associated with the Financial Advisor Scoring Unit 104. In at least one embodiment, database tables, such as those tables depicted in FIGS. 11A-11C, and/or profile information, such as the profiles previously discussed with respect to FIG. 2 may be stored or otherwise contained within the database portion 634 of the data storage 628. One or more components of the computing device 604 may communicate with one another utilizing a bus 640. Alternatively, or in addition, the financial advisor scoring unit 104 may be provided separate and apart from data storage 628. That is, as previously discussed, the financial advisor scoring unit 104, including the subgrouping unit 108, the cross-tabulation unit 112, the weighting unit 116, and the summing and scaling unit 120, may be implemented using a processor, such as a microprocessor 612. Accordingly, the microprocessor 612 may be specifically programmed to carry out one or more functions of the financial advisor scoring unit 104. For example, the processor 612 may execute instructions associated with the financial advisor scoring unit 104 including the subgrouping unit 108, the cross-tabulation unit 112, the weighting unit 116, and the summing and scaling unit 120 contained within memory 616 and/or storage 628.

The FARS 100 may be a distributed system and, in some embodiments, comprise communication network(s) 676 connecting one or more computing devices 604 and 608. That is, a portion of the FARS 104 may reside at the computing device 604 and a portion of the FARS 104 may reside at computing device 608. Alternatively, or in addition, a user at computing device 608 may provide input to the user input device 652, causing the FARS 104 to generate FAR Scores for financial advisors at the computing device 604 and transmit such information, utilizing the communication network 676, to the computing device 608 where such information may be processed and displayed at a user output 662.

That is, computing device 608 may include a processor 644, memory 648, one or more user input devices 652, such as a keyboard and a pointing device, and one or more user output devices 662, such as a display, speaker, and/or printer. Alternatively, or in addition, the user input 652 and the user output 662 may be combined into one device, such as a touch screen display. Computing device 608 may further include a communication interface 656 for communicating with another computing device 604, and/or the communication network 676.

Processor 644 is the same or similar to processor 612; that is, processor 644 is provided to execute instructions contained within memory 648 and/or storage 660. As such, the functionality of the computing device 608 is typically stored in memory 648 and/or storage 660 in the form of instructions and carried out by the processor 644 executing such instructions. Accordingly, the processor 644 may be implemented as any suitable type of microprocessor or similar type of processing chip. One example of the processor 644 may include any general-purpose programmable processor, digital signal processor (DSP) or controller for executing application programming contained within memory 648 and/or storage 660. Alternatively, or in addition, the processor 644, memory 648, and/or storage 660, may be replaced or augmented with an application specific integrated circuit (ASIC), a programmable logic device (PLD), or a field programmable gate array (FPGA).

The memory 648 is similar or the same as memory 616; that is, memory 648 generally comprises software routines facilitating, in operation, pre-determined functionality of the computing device 608. The memory 648 may be implemented using various types of electronic memory generally including at least one array of non-volatile memory cells (e.g., Erasable Programmable Read Only Memory (EPROM) cells or FLASH memory cells, etc.). The memory 648 may also include at least one array of dynamic random access memory (DRAM) cells. The content of the DRAM cells may be pre-programmed and write-protected thereafter, whereas other portions of the memory may selectively be modified or erased. The memory 648 may be used for either permanent data storage or temporary data storage.

The data storage 660 is the same or similar to data storage 628; that is, data storage 660 may generally include storage for programs and data. For example, data storage 660 may provide storage for an operating system, programs, and data 668. Storage 660 may also include browser 664. Although depicted separately, the browser 664 may render and cause web code or web content to be displayed to a user via an user output device, such as user output device 662, which is the same or similar to user output 624. In general, the layouts, or displays, provided in FIGS. 4A-4B and FIG. 5 may be displayed at the user output 662 and/or the user output 624. In instances where the layouts, or displays, are provided in a browser 664, such as when the FARS 104 is provided as a web service, webpage, or the like, the example layouts provided in FIGS. 4A-4B and FIG. 5 may be displayed at the user output 662 utilizing the browser 664, storage 660, memory 648, and processor 644. One or more components of the computing device 608 may communicate with one another utilizing a bus 672.

The communication network 676 may be packet-switched and/or circuit-switched. An illustrative communication network 676 includes, without limitation, a Wide Area Network (WAN), such as the Internet, a Local Area Network (LAN), a Personal Area Network (PAN), a Public Switched Telephone Network (PSTN), a Plain Old Telephone Service (POTS) network, a cellular communications network, an IP Multimedia Subsystem (IMS) network, a Voice over IP (VoIP) network, a SIP network, or combinations thereof. The Internet is an example of the communication network 676 that constitutes an Internet Protocol (IP) network including many computers, computing networks, and other communication devices located all over the world, which are connected through many communication systems and other means. In one configuration, the communication network 676 is a public network supporting the TCP/IP suite of protocols. Communications supported by the communication network 676 include real-time, near-real-time, and non-real-time communications. Moreover, the communication network 676 may comprise a number of different communication media such as coaxial cable, copper cable/wire, fiber-optic cable, antennas for transmitting/receiving wireless messages, and combinations thereof. In addition, it can be appreciated that the communication network 116 need not be limited to any one network type, and instead may be comprised of a number of different networks and/or network types. As can be appreciated, the FARS 100 may include a different number of computing devices 604 and 608; that is, there may be more or less computing devices than that which is illustrated in FIG. 6.

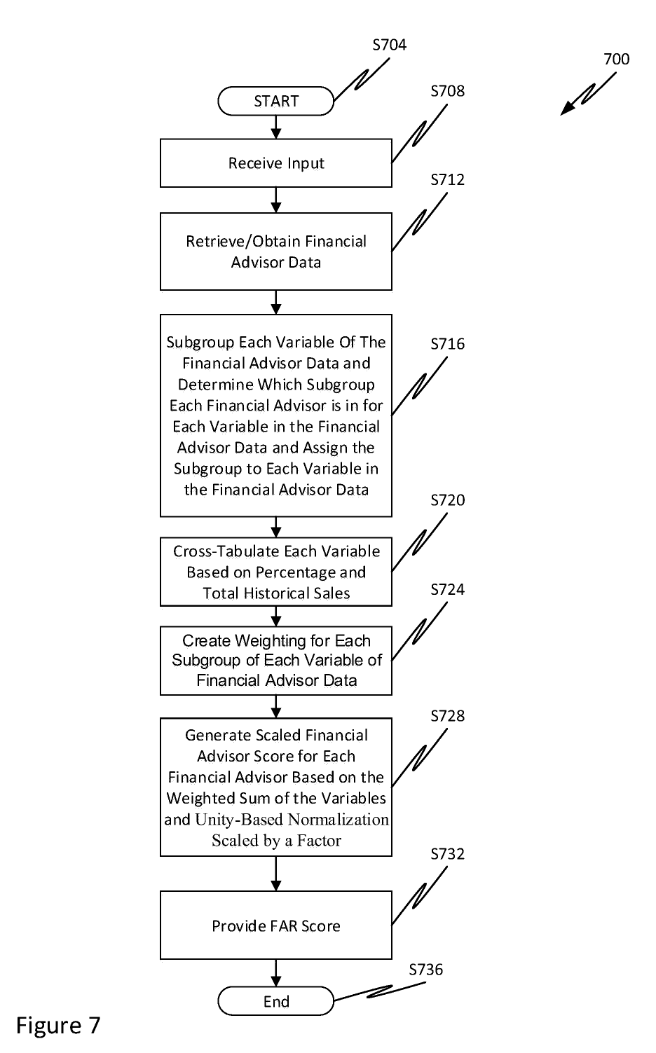

Referring now to FIG. 7, a method 700 of generating a FAR Score for a plurality of financial advisors will be discussed in accordance with embodiments of the present disclosure. Method 700 is in embodiments, performed by a device, such as the Financial Advisor Scoring Unit 104. More specifically, one or more hardware and software components may be involved in performing method 700. In one embodiment, one or more of the previously described units perform one or more of the steps of method 700. The method 700 may be executed as a set of computer-executable instructions executed by a computer system and encoded or stored on a computer-readable medium. Hereinafter, the method 700 shall be explained with reference to systems, components, units, software, etc. described with FIGS. 1-6.

Method 700 may continuously flow in a loop, flow according to a timed event, or flow according to a change in an operating or status parameter. Method 700 is initiated at step S704 where FAR Scores associated with one or more financial advisors are to be calculated. In some instances, method 700 may be initiated according to an established batch processing time. Alternatively, or in addition, method 700 may be initiated according to an on demand user request. At step S708, input may be received possibly indicating a subset of financial advisors, filtered by company, state, city, and/or zip code, in which to calculate and rank one or more FAR Scores. For example, out of 650,000 financial advisors, only 500,000 may be able to produce for a specific company; thus, these 500,000 financial advisors are selected and a FAR Score is calculated for each financial advisor. Alternatively, or in addition, at step S708 user input indicating which predictive model is to be used to generate the FAR Score is provided. That is, as previously discussed, non-limiting financial product predictive models include a Mutual Fund Predictive Model and/or a Variable Annuity Predictive Model. At step S712, financial advisor data is retrieved either locally or from a third party provider. The data retrieve may include one or more variables as required by a chosen predictive model.

Method 700 then proceeds to step S716, where each variable of the financial advisor data is subgrouped. Further, step S716 may determine which subgroup a variable associated with a financial advisor is in based on the previously determined subgroups. Accordingly, the variables associated with the financial advisor may be assigned a subgroup value. Such subgroup value may be assigned in a manner as previously discussed with respect to the subgrouping unit 108. Method 700 then proceeds to step S720, where each variable is cross-tabulated based on a percentage of financial advisors in each subgroup and the percentage of total historical sales for the financial advisors in each subgroup. Such cross-tabulating may be performed in a manner as previously discussed with respect to the cross-tabulating unit 112.

Method 700 then proceeds to step S724 where a weighting is determined for each subgroup of each variable of financial advisor data. That is, the weighting may be determined in a manner consistent with that which was previously discussed with respect to the weighting unit 116. Method 700 then proceeds to step S728 where a raw financial advisor score is generated for each financial advisor based on a weighted sum of the variables. Accordingly, such a raw financial advisor score is then scaled and/or normalized such that the FAR scores for all financial advisors range between one and 100. In some embodiments, a unity-based normalization, such as Equation 2, is utilized with a scale factor such that all FAR Scores range between one and 100. Alternatively, or in addition, the raw financial advisor score may be scaled and/or normalized in a manner consistent with that which was discussed with respect to the summing and scaling unit 120. Method 700 then proceeds to step S732 where the FAR Score associated with the financial advisors are provided to an output, such as a display or layout and depicted in FIGS. 4A-4B and/or FIG. 5. Method 700 then ends at step S736.

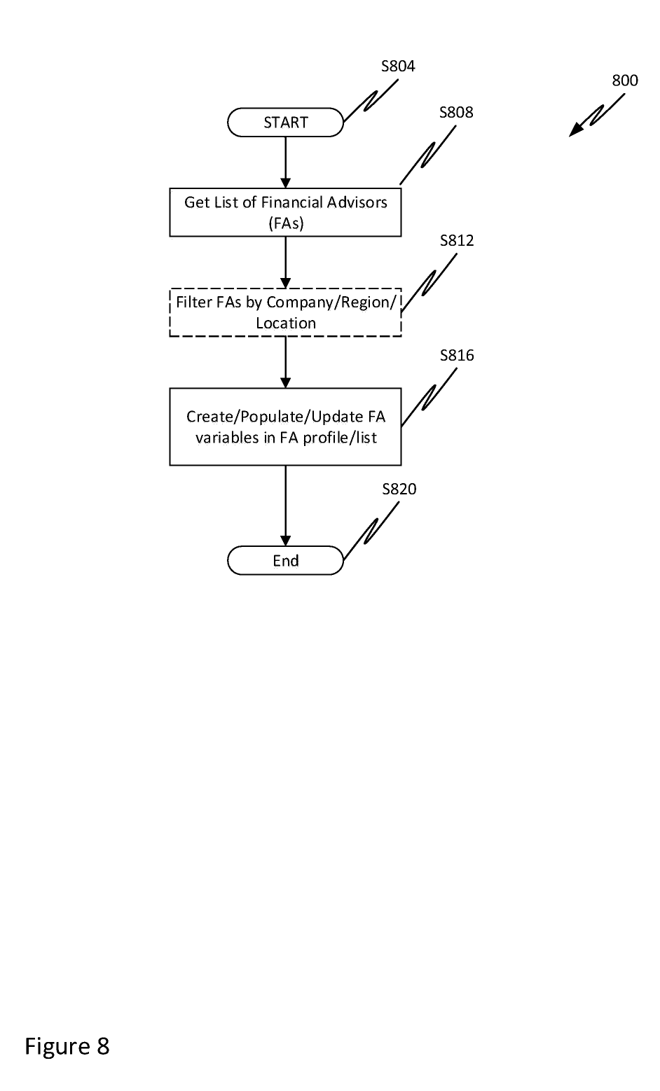

Referring now to FIG. 8, a method 800 of providing additional and/or alternative details of step S712 is provided in accordance with embodiments of the present disclosure. Method 800 is in embodiments, performed by a device, such as the Financial Advisor Scoring Unit 104. More specifically, one or more hardware and software components may be involved in performing method 800. In one embodiment, one or more of the previously described units perform one or more of the steps of method 800. The method 800 may be executed as a set of computer-executable instructions executed by a computer system and encoded or stored on a computer-readable medium. Hereinafter, the method 800 shall be explained with reference to systems, components, units, software, etc. described with FIGS. 1-7. Further, method 800 may be performed in a manner consistent with that which has been previously described with respect to the Financial Advisor Ranking Unit 104.

Method 800 may continuously flow in a loop, flow according to a timed event, or flow according to a change in an operating or status parameter. Method 800 is initiated at step S804 where one or more FAR Scores associated with one or more financial advisors are to be calculated. At step S808, a list of all financial advisors that can produce for a specified predictive model for a specified company are retrieved. As previously mentioned, such data may be available from third party vendors. Method 800 may then proceed to step S812, where the list of financial advisors is filtered by region, location, etc. For example, out of the 500,000 financial advisors that may be able to produce for a specified company, a user may wish to produce a FAR Score by sales territory or state. As one example, a salesperson may be responsible for the states of Colorado and Kansas; as such, the sales person may want FAR Scores produced that rank financial advisors only in the universe of Colorado and Kansas such that the salesperson can target the best prospects in this particular region. In most instances, the FAR Score will be calculated based on all financial advisors that may produce for a specified company. In particular, step S812 may be optional in that a user may not wish to filter such financial advisors. Accordingly, either utilizing the entire list of financial advisors that can produce for a company, or utilizing the filtered list of financial advisors, method 800 proceeds to step S816 where the financial advisor profile is created, populated, and/or updated along with the values for the variables indicated by a selected predictive model. Alternatively, or in addition, a financial advisor list is created including the values for the variables indicated by a selected predictive model. Method 800 may then end at step S820.

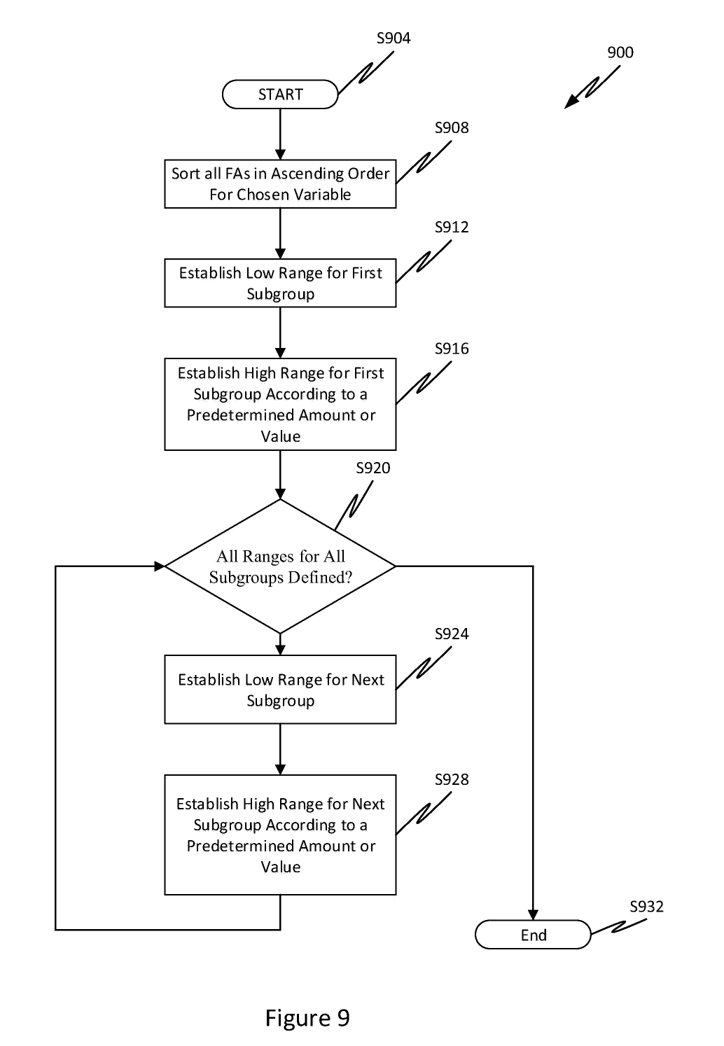

Referring now to FIG. 9, a method 900 of subgrouping each of the variables for a selected predicted model in accordance with step S716 is provided in accordance with embodiments of the present disclosure. Method 900 is in embodiments, performed by a device, such as the Financial Advisor Scoring Unit 104. More specifically, one or more hardware and software components may be involved in performing method 900. In one embodiment, one or more of the previously described units perform one or more of the steps of method 900. For example, the subgrouping unit 108 may perform all of or at least some of the steps of method 900. The method 900 may be executed as a set of computer-executable instructions executed by a computer system and encoded or stored on a computer-readable medium. Hereinafter, the method 900 shall be explained with reference to systems, components, units, software, etc. described with FIGS. 1-8. Further, method 900 may be performed in a manner consistent with that which has been previously described with respect to the subgrouping unit 108 and Financial Advisor Ranking Unit 104.

Method 900 may continuously flow in a loop, flow according to a timed event, or flow according to a change in an operating or status parameter. Method 900 is initiated at step S904 where the variables associated with all of or the selected financial advisors are subgrouped. At step S908, all financial advisors are sorted in ascending order according to the chosen variable. For example, if the chosen variable relates to years of experience, the financial advisors are sorted in ascending order according to the years of experience. Next, method 900 proceeds to step S912 where a low range for a first subgroup is established. That is, the lowest value in the list of sorted financial advisors for the chosen variable is determined to be the low range for the first subgroup. Method 900 then proceeds to step S916 where a high range is established for a first subgroup according to a predetermined amount or value. For example, if four groups are to be chosen, then a value located at a position 25% down the list of ascending financial advisors is chosen for the high value for subgroup 1. Alternatively, if five groups are to be chosen, then a value located at a position roughly 20% down the list of ascending financial advisors is chosen for the high value for subgroup 1. Method 900 then proceeds to step S920 where it is determined whether all ranges for all subgroups have been defined. If the ranges for all subgroups have been defined, method 900 proceeds to step S932 where method 900 ends.

Otherwise, method 900 proceeds to step S924 where the low range for the next subgroup is established based on the high range established for the previous group, in this case the first subgroup. Method 900 then proceeds to step S928 where the high range for the next subgroup is determined according to the predetermined amount or value in a manner similar to that which was described with respect to step S916. Method 900 then proceeds back to step S920 where again it is determined whether all ranges for all subgroups have been defined.

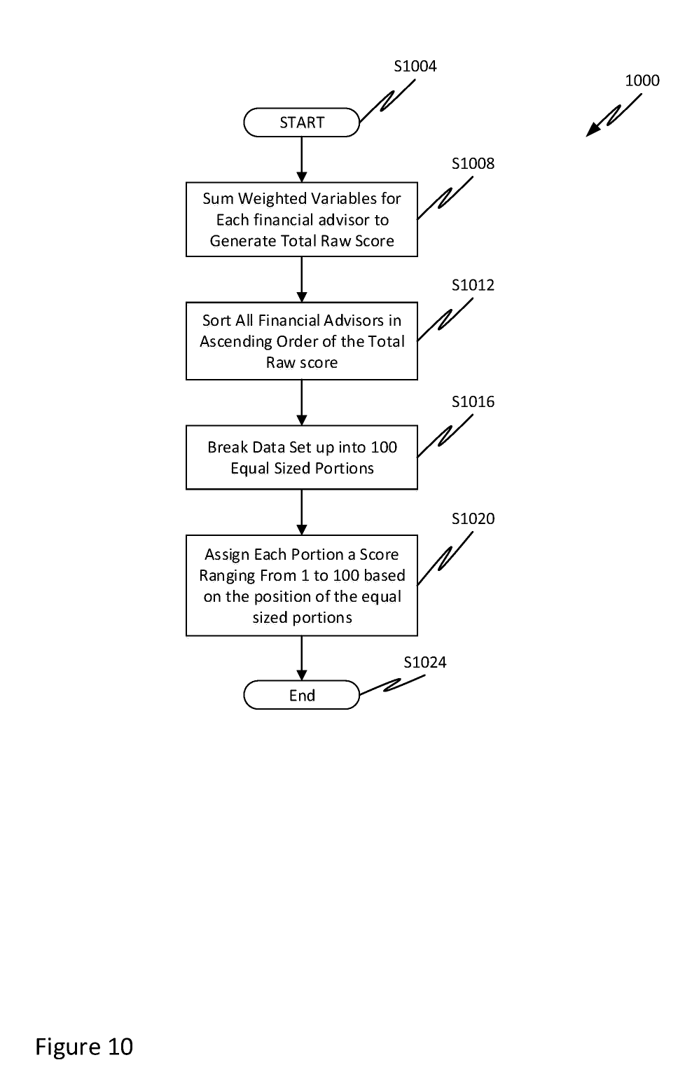

Referring now to FIG. 10, a method 1000 of providing additional details of step S728 is provided in accordance with embodiments of the present disclosure. Method 1000 is in embodiments, performed by a device, such as the Financial Advisor Scoring Unit 104. More specifically, one or more hardware and software components may be involved in performing method 1000. In one embodiment, one or more of the previously described units perform one or more of the steps of method 1000. For example, the summing and scaling unit 120 may perform all of or at least some of the steps of method 1000. The method 1000 may be executed as a set of computer-executable instructions executed by a computer system and encoded or stored on a computer-readable medium. Hereinafter, the method 1000 shall be explained with reference to systems, components, units, software, etc. described with FIGS. 1-9. Further, method 1000 may be performed in a manner consistent with that which has been previously described with respect to the summing and scaling unit 120 and/or the Financial Advisor Ranking Unit 104.

Method 1000 may continuously flow in a loop, flow according to a timed event, or flow according to a change in an operating or status parameter. Method 1000 is initiated at step S1008 where the weighted variables for each financial advisor are summed thereby generating a Total_Raw_Score for each financial advisor. Method 1000 then proceeds to step S1012 where financial advisors are sorted in ascending order according to the total raw score. In some embodiments, the financial advisors may be sorted in a list format. Method 1000 then proceeds to step S1016 where the data set containing the sorted financial advisors is broken up into 100 equal sized portions. Method 1000 then proceeds to step S1020 where each of the 100 equal sized portions of the data set are assigned a score ranging from one to 100 based on a position in the sorted data set. For example, if there are 500,000 financial advisors in the data set, the first 5,000 rows (or 1%) will have a FAR score of 1. Likewise, the next 5,000 rows will have a FAR Score of 2. The bottom 5,000 rows will have a value of 100 for a FAR Score. Method 1000 then ends at step S1024. Accordingly, the financial advisors with a FAR score of 100 are the best prospects while those with a score of 1 are the worst prospects.

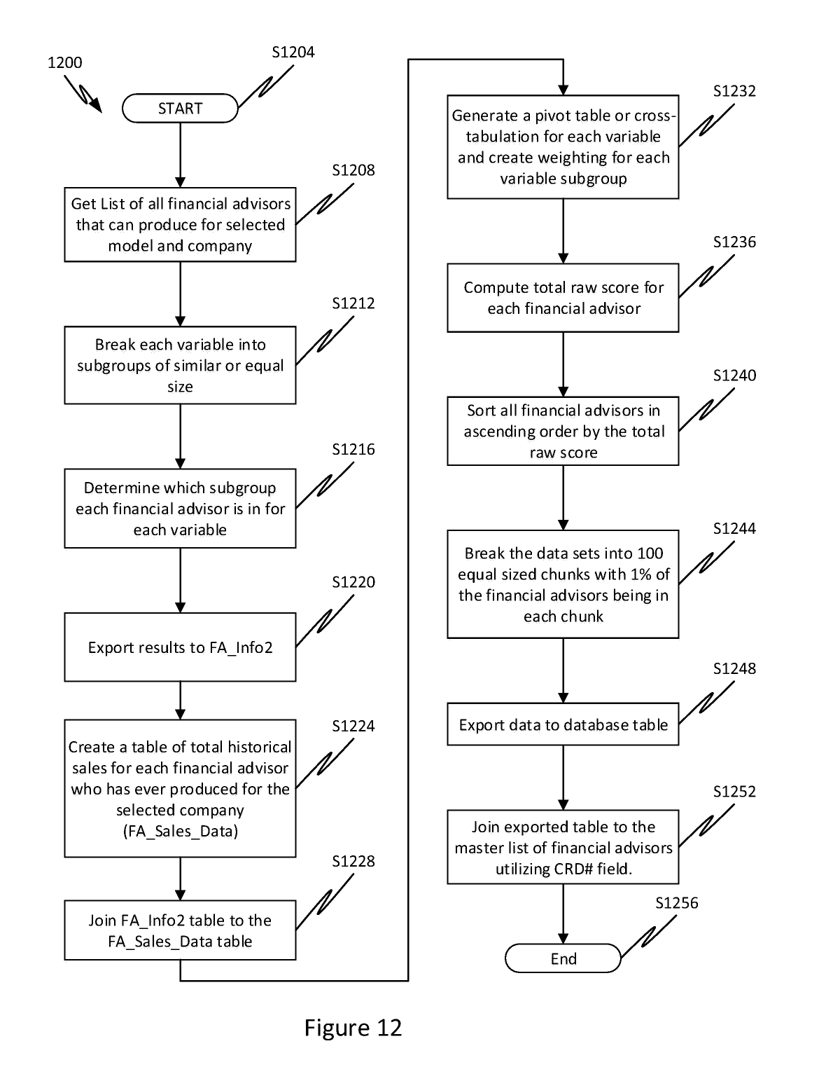

In accordance with some embodiments of the present disclosure, data tables, such as those in FIGS. 11A-11B may be utilized in the FAR Score generation process. For example, as will be described with respect to FIG. 12, a table 1104 named FA_Info, a table 1108 named FA_Sales_Data, a table 1112 named FA_Info_2, a table 1116 named FA_Data_And_Sales, a table 1120 named FA_Data_And_Sales, and a data table 1124 named FA_Data_And_Sales may be utilized throughout the FAR Score generation process.

Referring now to FIG. 12, a method 1200 of generating a FAR Score for a plurality of financial advisors will be discussed in accordance with embodiments of the present disclosure. Method 1200 is in embodiments, performed by a device, such as the Financial Advisor Scoring Unit 104. More specifically, one or more hardware and software components may be involved in performing method 1200. In one embodiment, one or more of the previously described units, such as the financial advisor scoring unit 104, subgrouping unit 108, cross-tabulation unit 112, weighting unit 116, and summing and scaling unit 120, perform one or more of the steps of method 1200. The method 1200 may be executed as a set of computer-executable instructions executed by a computer system and encoded or stored on a computer-readable medium. Hereinafter, the method 1200 shall be explained with reference to systems, components, units, software, etc. described with FIGS. 1-11C.

Method 1200 may continuously flow in a loop, flow according to a timed event, or flow according to a change in an operating or status parameter. Method 1200 is initiated at step S1204 where the method 1200 is initiated in response to one or more events. For example, method 1200 may be executed according to a pre-determined frequency (.e.g. daily, weekly, monthly etc.) or upon receiving an input. In some instances, method 1200 may be initiated on demand. Accordingly, at step S1208 a list of all financial advisors that can produce for a specific predictive model for a specified company, for example a Mutual Fund predictive model, including the financial advisor's unique FINRA CRD number (CRD#) and values relating to the variables utilized by the specific predictive model are obtained. For example, the value relating to those variables in Table 1 and/or Table 2 may be obtained for each financial advisor. Such data is generally available from third party vendors. This data is then imported into a database table; for example, the database table may have the necessary fields required to hold the data, such as table 1104 FA_Info of FIG. 11A.

The method 1200 then proceeds to step S1212 where each of the variables are broken down into 3 to 6 subgroups of similar or equal size. For example, and as previously described with respect to the subgrouping unit 108, to determine the cutoff points for each subgroup in a variable, a unit, such as the subgrouping unit 108, sorts all the financial advisors by their value for the variable in ascending order. The first (lowest) value in the list will be the low range for subgroup1. Then, for example, the value 25% down the list (for example, if the list has 400,000 rows or FAs, go down to row 100,000) is used for the high value for subgroup1. Once all variables have been subgrouped, method 1200 proceeds to step S1216 where it is determined which subgroup each financial advisor is in for each variable. For each variable utilized by the predictive model, a new column is created to hold the value of the subgroup that the financial advisor is in. Accordingly, at step S1220, the results of subgrouping and determining which subgroup the financial advisor is in for each variable may be exported to a table, such as table 1112 named FA_Info_2 as illustrated in FIG. 11A.

Method 1200 then proceeds to step S1224 where a table comprising total historical sales for each financial advisor who has ever produced for the selected company is created. As one example, the table may have two columns, where one column contains the unique CRD number for each financial advisor and the other column contains the value corresponding to the total sales each financial advisor has produced for the company. An exemplary table, such as table 1108 named FA_Sales_Data, may be used and is provided in FIG. 11A. Method 1200 then proceeds to step S1228 where the table containing the total sales for each financial advisor who has ever produced for the selected company, such as table 1108 named FA_Sales_Data, is joined to the table containing the subgrouping results for each financial advisor, for example table 1112 named FA_Info_2. The joining of the two tables may generate a new table, such as table 1116 named FA_Data_And_Sales as illustrated in FIG. 11A. In one embodiment, an outer join is utilized such that what remains is a set of results showing one row for each financial advisor whether or not the financial advisor has produced for the selected company. Accordingly, each row for each financial advisor will have a necessary number of columns to reflect the value for each variable, the associated subgroup for each variable, a CRD# associated with the financial advisor, and column indicating the selected company's total sales for each financial advisor (i.e. a row named Total_Sales). If, for example, the financial advisor never produced, or never sold any financial products, for the selected company, the value of Total_Sales would be zero.

Method 1200 then proceeds to step S1232 where a pivot table is built such that a cross-tabulation for each variable showing a percentage of the financial advisors that are in each subgroup and a percentage of the selected company's sales for each subgroup are determined. As one example, such data may be similar to that which is illustrated in FIGS. 3A and 3B. Additionally, the cross-tabulation may be performed by the cross-tabulation unit 112 as previously described. Additionally, step S1232 may generate a weighting for each subgroup. For example, the weighting unit 116 may utilize Equation 1 to produce a weight for each subgroup in each of the utilized variables. That is, a weighting for each subgroup may be generated so “good” subgroups get positive numbers and “bad” subgroups get negative numbers. The better or worse a subgroup is, the higher or lower the weighting will be. A new column may then be utilized in the data set for each financial advisor for each variable to hold the weighing for each of the variables utilized for the specific model. For example the resulting table 1120 named FA_Data_And_Sales, as illustrated in FIG. 11B, may be utilized for each financial advisor; that is, each variable in the table 1120 includes an associated weighting.

Method 1200 then proceeds to step S1236 where a total raw score is calculated for each financial advisor by adding up the weightings applied to each variable utilized in the specified model. For example, the total raw score may be calculated utilizing the javascript disclosed in Table 15. A new column may be utilized to hold this data; such a column may be titled “Total_Raw_Score” as depicted in table 1124 named FA_Data_And_Sales of FIG. 11C. Method 1200 then proceeds to step S1240 where all financial advisors may be sorted in ascending order of the value contained in the Total_Raw_Score column. After sorting the financial advisors, the method 1200 then proceeds to step S1244 where the sorted data set is broken up into a specified number of equal sized portions. For example, and in accordance with some embodiments of the present disclosure, the resultant data set may be broken up into 100 equal sized portions such that one percent of the financial advisors belong to each portion. Accordingly, the top one percent of the financial advisors with respect to their total raw score will be assigned a FAR Score of 100, the one percent of the financial advisors below the top one percent will be assigned a score of ninety-nine, and so on down to the bottom 1% being assigned a FAR Score of 1. An exemplary process to assign the scores may include performing the following steps. First a column called ‘Count’ is added to the data set resulting from Step S1240 which is sorted in ascending order of Total_Raw_Score; the column ‘Count’ may be assigned a value of 1 for this column for every row (each row contains one financial advisor's data) in the data set. Next, a column called ‘Cumulative’ is created which is a cumulative total of the ‘Count’ column up to and including each row. For example, the value for the fifth row of the Cumulative column is calculated by adding up rows 1 through 5 of the Count column which produces a value of 5. If, for example, there are 500,000 financial advisors in the data set, the last row will have a value of 500,000 for this column. Next, a column called ‘FAR_Score’ is created and the following formula may be used to compute the value for each row:

$$FAR\_Score = Ceil ( \frac{Cumulative}{Sum ( Count )} 100 ) \qquad Equation 3$$

For example, the “Ceil” function takes a number and returns the next highest integer above the number. Equation 3 first divides the value in the Cumulative column for the row by the total number of rows and then multiplies this result by 100. The “Ceil” function then returns the next highest integer above this number. Since the data set is sorted in ascending order by Total_Raw_Score for each FA, those financial advisors having the lowest total raw scores are at the top of the list. For example, if there are 500,000 financial advisors in the data set, the first 5,000 rows (or 1%) will have a FAR Score of 1

Likewise, the next 5,000 rows will also have a FAR Score of 2. The bottom 5,000 rows (i.e. the rows with the highest total raw scores) will have a value of 100 for this ‘FAR_Score’ column. Thus, step S1244 generates and assigns a FAR Score between 1 and 100 for all financial advisors who can produce for a specified company.

Method 1200 may then proceed to step S1248 where the FAR Scores for the financial advisors may be exported to a database table, and a new table, such as table 1124 in FIG. 11C is generated by joining the table of FAR Scores and the list of financial advisors and the desired demographic and professional data. Additionally, one can export this data set to a new table (the name is arbitrary) and that table can be used for targeting purposes. One can also join tables with other data (meetings, calls, market share data, etc.) to this new table, if desired, by basing the join on the CRD# field. FIGS. 4A, 4B and 5 are examples of how the final data and FAR scores can be used. For example, the FAR Scores may be displayed to a user via a dashboard. In some embodiments, additional information may be presented along with the FAR Score.

The exemplary systems and methods of this disclosure have been described in relation to a financial advisor ranking technique. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein discuss the various components of the system collocated, certain components of the system can be located remotely, at distant portions of a distributed network, such as a LAN and/or the Internet, or within a dedicated system and/or within a cloud computing environment. Thus, it should be appreciated, that the components of the system can be combined in to one or more devices, such as a computer, computing device and/or server(s), or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as RID, PLA, FPGA, PAL, special purpose computer, any comparable means, or the like, in general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized. In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure, it is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for generating an indication of a financial advisor's ability to produce for a financial product, the method comprising:
obtaining a financial advisor profile associated with each financial advisor of a plurality of financial advisors, the financial advisor profile comprising a plurality of variables;
generating, by a financial advisor scoring unit have a processor and memory, a weighting associated with each variable of the financial advisor profile;
generating, by the financial advisor scoring unit, a financial advisor score for each financial advisor by summing the weighting associated with each variable of the financial advisor profile; and
providing the financial advisor score associated with at least one financial advisor to a display device.

2. The method of claim 1, wherein generating the weighting associated with each variable of the financial advisor profile includes:
for each variable of the plurality of variables:
creating two or more subgroups based upon a value of the variable for each financial advisor of the plurality of financial advisors;
associating at least one of the two or more subgroups for each variable of the plurality of variables to each financial advisor;
generating a subgroup weighting for each subgroup of the two or more subgroups based on an amount of financial advisors in each subgroup and respective sales of the financial product attributed to the amount of financial advisors in each subgroup; and
assigning a weighting to each variable of the financial advisor profile based on the associated subgroup and the subgroup weighting.

3. The method of claim 2, wherein the subgroup weighting for each subgroup is generated based on the following formula:
$$\frac{\% of Sales - \% of FAs}{\% of FAs} ,$$
where % of Sales is equal to a percent of sales attributed to the financial advisors in each subgroup and % of FAs is equal to a percent of financial advisors in each subgroup.

4. The method of claim 1, wherein the plurality of variables of the financial advisor profile include at least a number of states the financial advisor is licensed in, a number of licenses associated with the financial advisor, a number of years of experience associated with the financial advisor, an age of the financial advisor, assets under management by the financial advisor, and gross annual production of the financial advisor.

5. The method of claim 4, wherein the plurality of variables of the financial advisor profile further includes at least one of (i) whether the financial advisor sells or advises on mutual funds, (ii) whether the financial advisor sells or advises on annuities, and (iii) a gender of the financial advisor.

6. The method of claim 1, generating a financial advisor score further comprises:
scaling the summed value of the weighting associated with each variable of the financial advisor profile.

7. The method of claim 1, further comprising:
displaying, at the display device, the financial advisor score associated with at least one financial advisor.

8. The method of claim 1, wherein the financial advisor score for each financial advisor is associated with a financial product of a selected company.

9. A computer readable storage medium comprising processor executable instructions operable to perform the method of claim 1.

10. A method for generating an indication of a financial advisor's ability to produce for a financial product, the method comprising:
obtaining a financial advisor profile associated with each financial advisor of a plurality of financial advisors, the financial advisor profile comprising a plurality of variables indicating a number of states the financial advisor is licensed in, a number of licenses associated with the financial advisor, a number of years of experience associated with the financial advisor, an age of the financial advisor, assets under management by the financial advisor, and a gross annual production of the financial advisor;
generating, by a financial advisor scoring unit have a processor and memory, a weighting associated with each variable of the financial advisor profile; and
generating, by the financial advisor scoring unit, a financial advisor score for each financial advisor by summing the weighting associated with each variable of the financial advisor profile; and
providing the financial advisor score associated with at least one financial advisor to a display device.

11. The method of claim 10, wherein generating the weighting associated with each variable of the financial advisor profile includes:
for each variable of the plurality of variables:
creating two or more subgroups based upon a value of the variable for each financial advisor of the plurality of financial advisors;
associating at least one of the two or more subgroups for each variable of the plurality of variables to each financial advisor;
generating a subgroup weighting for each subgroup of the two or more subgroups based on an amount of financial advisors in each subgroup and respective sales of the financial product attributed to the amount of financial advisors in each subgroup; and
assigning a weighting to each variable of the financial advisor profile based on the associated subgroup and the subgroup weighting.

12. The method of claim 10, wherein the plurality of variables of the financial advisor profile further indicate at least one of (i) whether the financial advisor sells or advises on mutual funds and (ii) whether the financial advisor sells or advises on annuities.

13. The method of claim 12, wherein the plurality of variables of the financial advisor profile further indicate at least one of a gender of the financial advisor, whether the financial advisor has a Series 7 license, whether the financial advisor has a Series 26 license, whether the financial advisor has a Series 65 license, whether the financial advisor is a Certified Financial Planner (CFP), whether the financial advisor is a Chartered Financial Consultant (ChFC), whether the financial adviser is a Certified Public Accountant (CPA), whether the financial adviser is an insurance agent, whether the financial adviser sells or recommends bonds, whether the financial adviser sells or recommends stocks, whether the financial adviser works for a broker dealer of the type Bank, whether the financial advisor works for a broker dealer of the type regional, whether the financial adviser has an affluent home.

14. A computer readable storage medium comprising processor executable instructions operable to perform the method of claim 10.

15. A computing based system comprising:
a database;
one or more processors; and
a financial advisor scoring unit, the financial advisor scoring unit configured to obtain from the database a plurality of variables associated with each financial advisor of a plurality of financial advisors, generate a weighting associated with each variable associated with the financial advisor, and generate a financial advisor score for each financial advisor by summing the weighting associated with each variable associated with the financial advisor.

16. The system of claim 15, wherein the financial advisor scoring unit is further configured to create two or more subgroups based upon a value of the variable for each financial advisor of the plurality of financial advisors, associate at least one of the two or more subgroups for each variable of the plurality of variables to each financial advisor, generate a subgroup weighting for each subgroup of the two or more subgroups based on an amount of financial advisors in each subgroup and respective sales of the financial product attributed to the amount of financial advisors in each subgroup, and assign a weighting to each variable associated with the financial advisor profile based on the associated subgroup and the subgroup weighting.

17. The system of claim 15, wherein the subgroup weighting for each subgroup is generated based on the following formula:
$$\frac{\% of Sales - \% of FAs}{\% of FAs} ,$$
where % of Sales is equal to a percent of sales attributed to the financial advisors in each subgroup and % of FAs is equal to a percent of financial advisors in each subgroup.

18. The system of claim 15, wherein the plurality of variables include at least a number of states the financial advisor is licensed in, a number of licenses associated with the financial advisor, a number of years of experience associated with the financial advisor, an age of the financial advisor, assets under management by the financial advisor, and gross annual production of the financial advisor.

19. The system of claim 15, wherein the plurality of variables further includes at least one of (i) whether the financial advisor sells or advises on mutual funds, (ii) whether the financial advisor sells or advises on annuities, and (iii) a gender of the financial advisor.

20. The system of claim 15, wherein the financial advisor scoring unit outputs a financial advisor score to a display device.
